(19) United States
(12) Patent Application Publication
(10) Pub. No.: US 2009/0150767 A1
(43) Pub. Date: Jun. 11, 2009

(54) SERVER HAVING DYNAMIC WEB PAGE CREATING FUNCTION

(75) Inventor: Yasuo SUGAHARA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/247,533

(22) Filed: Oct. 8, 2008

(30) Foreign Application Priority Data
Dec. 6, 2007 (JP) 2007-315711

(51) Int. Cl. G06F 17/00

(52) U.S. Cl. 715/239

(57) ABSTRACT

A server having a dynamic Web page creating function has a storing unit that receives a description language file in which a special keyword for converting a Web page component is embedded from a first device. The storing unit stores the description language file in a storage unit. A detecting unit detects the special keyword in the stored description language file by syntax analysis when a Web page browsing request is submitted from a second device. A converting unit converts the detected special keyword into a character string according to a predetermined rule. A generating unit generates a description language file including the converted character string to be transmitted back to the second device.

### CROSS-REFERENCE TO RELATED APPLICATIONS

This application is related to and claims priority to Japanese Patent Application No. 2007-315711, filed on Dec. 6, 2007 in the Japanese Patent Office, the entire contents of which are incorporated by reference herein.

### BACKGROUND

1. Field

The present invention relates to a server having a dynamic Web page creating function and, more specifically, to a dynamic Web page creating method and program, and a computer readable record medium.

2. Description of the Related Art

A Web page created using only static HTML (Hyper Text Markup Language) is always displayed in a client terminal in the same state with the same information to any user.

However, an individual dynamic element, such as a user name, has to be displayed depending on the user who accesses a Web server from the client terminal.

In general, the Web page including a dynamic element (dynamic Web page) is provided to the client terminal by cooperative processing with a program such as a CGI (Common Gateway Interface) or a script performed by the Web server.

Meanwhile, a skill and an environment to develop a program are necessary to create a programmed dynamic Web page. Thus, a single Web designer cannot create a Web page and the Web designer cannot design a Web page using either a widely distributed Web authoring tool or a home page builder.

### SUMMARY

An object is to provide a technique for enabling a Web designer according to a situation and a request even though the Web designer has no skill and environment to develop a program for creating a dynamic Web page.

Another object is to provide a technique for creating a dynamic Web page by cooperating with existing software such as an authoring tool, a browser, and a cookie.

To solve the above described problems, a server having the dynamic Web page creating function has a storing unit that receives a description language file in which a special keyword for converting a Web page component is embedded from a first device, and stores the description language file in a storage unit, and a detecting unit that detects the special keyword in the stored description language file by syntax analysis when a Web page browsing request is submitted from a second device and a converting unit that converts the detected special keyword into a character string according to a predetermined rule, and a generating unit that generates a description language file including the converted character string to be transmitted back to the second device.

The above-described embodiments of the present invention are intended as examples, and all embodiments of the present invention are not limited to including the features described above.

### BRIEF DESCRIPTION OF THE DRAWINGS

FIG. 1 is a block diagram showing an overview configuration of a system of an embodiment of the invention;

FIG. 2 is a block diagram showing a detailed configuration of the system of an embodiment of the invention;

FIG. 3A is a diagram showing an example of an editor screen (add-on screen) of an authoring tool in a Web designer terminal;

FIG. 3B is a diagram showing a display example of a special keyword to the editor screen of the Web designer terminal;

FIG. 4 is a flowchart illustrating a keyword conversion process in a Web server;

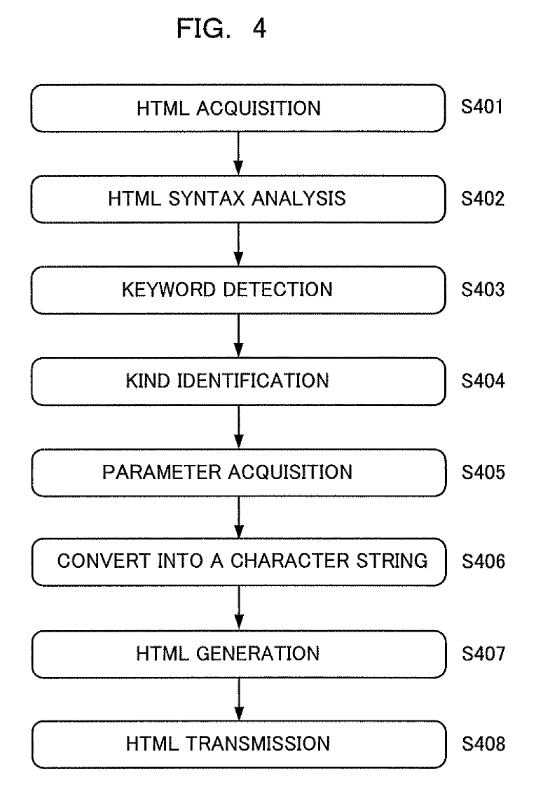

FIG. 5A is a flowchart illustrating a first specific example of the keyword conversion process in the Web server;

FIG. 5B is a diagram showing a notation example in an HTML file and a display example in a browser on the first specific example of the keyword conversion processing;

FIG. 6A is a flowchart illustrating a second specific example of the keyword conversion process in the Web server;

FIG. 6B is a diagram showing a notation example in an HTML file and a display example in a browser on the second specific example of the keyword conversion process;

FIG. 6C is a diagram showing a configuration example of a user information table;

FIG. 7A is a flowchart illustrating a third specific example of the keyword conversion process in the Web server;

FIG. 7B is a diagram showing a notation example in the HTML file and a display example in the browser on the third specific example of the keyword conversion processing; and

FIG. 7C is a diagram showing a configuration example of a merchandise list table.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

More detailed description is made below with reference to attached figures. Preferred embodiments are shown in the figures. However, the embodiments can be performed in various forms. It should not be interpreted that the present invention is limited to the embodiments described in the present specification. These embodiments are provided in order to make a disclosure of the present specification exhaustive and perfect and to sufficiently indicate a range of the present invention to those who skilled in the art. The same numbers and codes indicate the same elements throughout the embodiments.

System Configuration

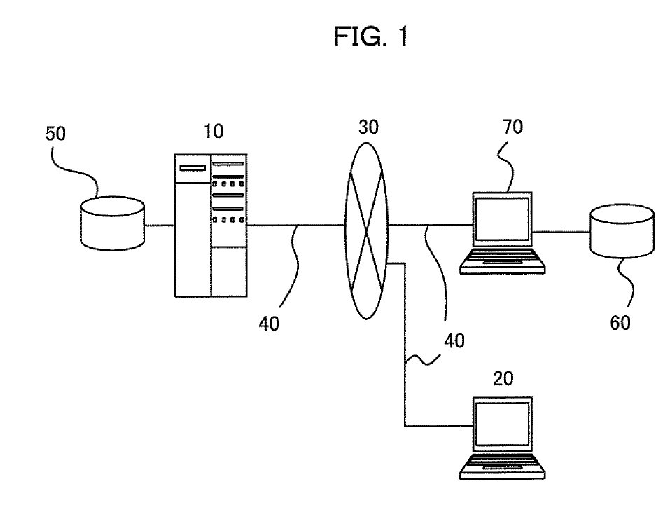

With reference to FIG. 1 showing a configuration of a system in an embodiment, in a dynamic Web page creation system SYS, a general Web server 10, a Web designer terminal 20, and a client terminal 70 are connected through a communication line 40 of a network 30 such as internet.

An HTML document (file) corresponding to a Web page provided from the Web server (hereinafter may be referred to as just server) 10 to the Web designer terminal (hereinafter may be referred to as just designer terminal) 20 used by a Web designer is held (stored) in a database (DB) 50 that is connected to or built in the server 10. Further, a cookie 60 can be recorded in the client terminal 70 used by a general user.

The Web server 10 is a server computer including a hard disk drive device as a central control device, a main storage device, and an auxiliary storage device, and a communication interface. In this case, however, figures of this configuration are omitted.

The Web designer terminal 20 and the client terminal 70 can be achieved by a computer such as a personal computer with a Web browser. The computer includes a hard disk drive device as a central control device, a main storage device, and an auxiliary device, a display device as a display, a keyboard and a mouse as an input device, and a communication interface. In this case, however, figures of this configuration are omitted.

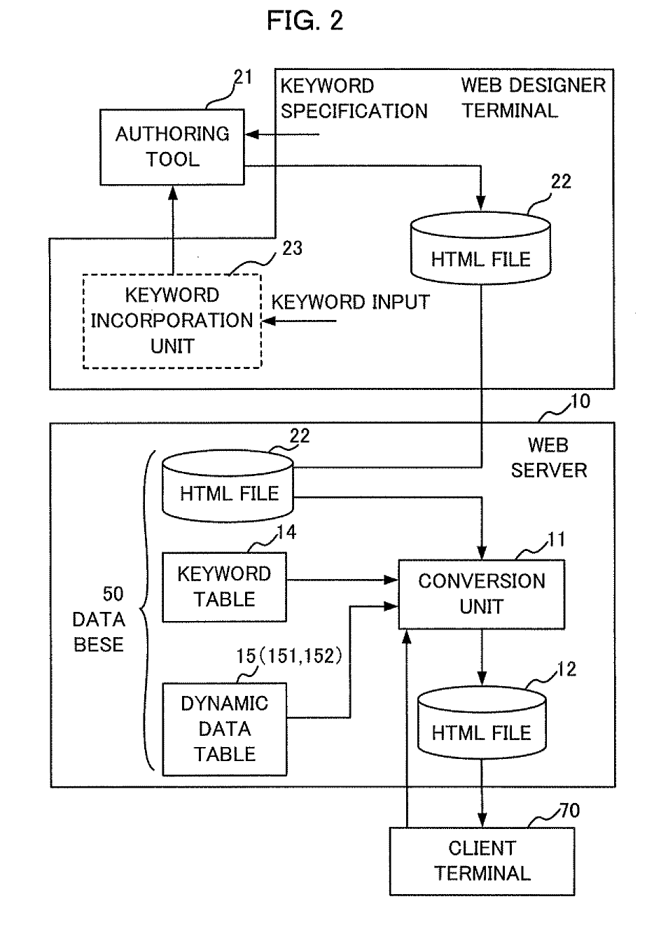

To logically achieve the dynamic Web page creating function described later, as shown in FIG. 2, the system SYS includes a conversion unit 11 and the database 50 in the Web server 10. The system SYS also has a keyword incorporation unit 23 that cooperates with a Web authoring tool (or a home page builder) 21 in the Web designer terminal 20.

However, the keyword incorporation unit 23 does not have to be provided, depending on how a special keyword (hereinafter may be referred to as just keyword) is input, as described later. The database 50 includes an HTML file 22 in which the special keyword has been embedded, a keyword table 14, and a dynamic data table 15.

Further, the system SYS generates an HTML file 12 if a Web page browsing request is submitted from the client terminal 70 used by a user. The special keyword was converted into a character string in the HTML file 12 (after keyword conversion processing) in the Web server 10 based on the HTML file 22 in which the special keyword was embedded. The HTML file 22 was generated by the Web designer terminal 20.

Further, the system SYS employs the above described configuration and installs a control program into the auxiliary storage device of the Web server 10.

Dynamic Web Page Creating Operation

Next, description is made of an operational example of the dynamic Web page creation system SYS of an embodiment shown in FIG. 1 and FIG. 2 with reference to associated figures.

Processing Overview

When a Web designer who has no skill or environment to develop a program wants to transmit a conversion request (i.e., a conversion request of a Web page component) of a static Web page to the Web server 10, the Web designer uses the Web authoring tool 21 in the Web designer terminal 20 in order to define (specify) a special keyword that the Web server 10 can understand.

After generating the HTML file 22 in which this keyword is embedded by using the Web authoring tool 21, the Web designer transmits the HTML file 22 to the Web server 10 from the designer terminal 20.

After receiving the HTML file 22 in which the keyword has been embedded, which was transmitted from the designer terminal 20 through the communication interface, the Web server (the central control device) 10 stores the HTML file 22 in the database 50.

The conversion unit 11 of the Web server 10 acquires the HTML file 22 in which the special keyword has been embedded corresponding to the requested Web page and detects the special keyword in the HTML file 22 by syntax analysis, when a Web page browsing request is submitted from the client terminal 70 used by a general user.

The conversion unit 11 refers to the keyword table 14 and the dynamic data table 15 according to need, and converts the keyword into a character string (keyword conversion) in accordance with a predetermined rule when the conversion unit 11 detects the special keyword in the HTML file 22.

The conversion unit 11 generates the HTML file 12 to which the keyword conversion process is applied. The conversion unit 11 transmits (transmits back) the HTML file 12 as a desired Web page to the client terminal 70 through the communication interface. If the cookie 60 is transmitted from the client terminal 70 during the keyword conversion, the conversion process can be changed depending on the content thereof.

This allows the Web designer who has no skill or environment to develop a program to create a dynamic Web page in the designer terminal 20.

Processing Details: Web Designer Terminal

To change a component of a certain Web page, the Web designer uses the Web authoring tool 21 in the Web designer terminal 20 to specify a special keyword that the Web server 10 can understand.

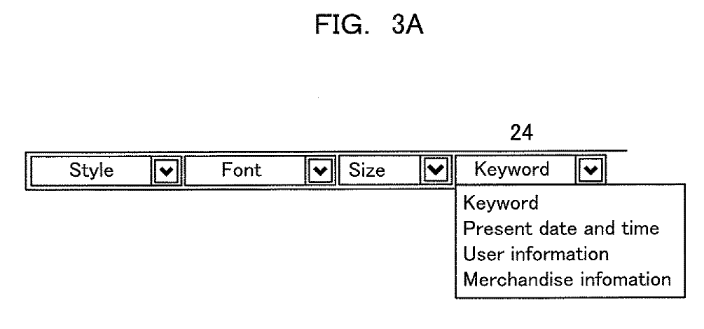

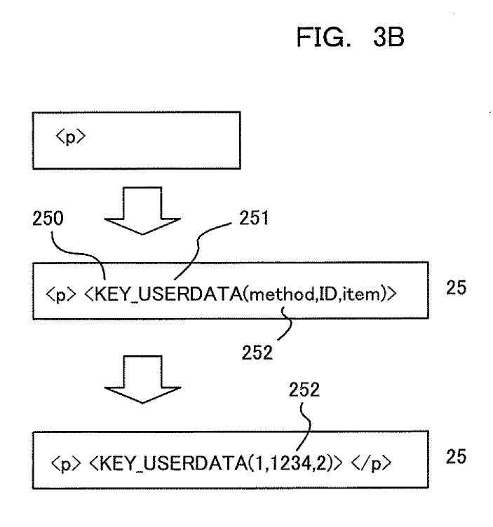

Therefore, the Web designer displays an editor screen of the authoring tool 21 in a display device of the Web designer terminal 20 through a predetermined selecting (specifying) operation by the keyboard and the mouse. As shown in FIG. 3A, a tool bar of this editor screen is added with a pull-down menu 24 for specifying a keyword.

When the Web designer selects any of the keywords in the pull-down menu 24, the specified keyword (user information in this case) is displayed in the editor screen.

FIG. 3B shows a display example on the editor screen in the case when the user information is specified as a keyword. The Web designer can rewrite a parameter 252 of a displayed keyword 251 (specifically, information indicating a type of the keyword to be converted) according to need by operating the mouse or the keyboard. In this case, the Web designer rewrites the parameter (method, ID, item) 252 of a keyword “USERDATA” 252 to a parameter (1, 1234, 2).

To rewrite the parameter, the pull-down menu 24 and the displayed parameter 252 in the editor screen of the authoring tool 21 can be selected from data displayed by clicking the mouse. Further, it is applicable that a value of each parameter 252 is input from the keyboard to cooperate with the authoring tool 21 through the keyword incorporation unit 23.

In general, a format of the special keyword 25 can be expressed in “<$KEY_type (param1, param2, . . . paramN)>”. In this case, “KEY” 250 indicates the identification information of the keyword character string. “type” 251 indicates a type of the keyword to be converted. “param#” 252 is a parameter (variable number) that is used for conversion. The number of necessary parameters varies depending on a type of the keyword.

After generating the HTML file 22 in which the special keyword is embedded in the body therein by cooperative processing of the authoring tool 21 and the keyword incorporation unit 23 according to need, the Web designer terminal 20 transmits the HTML file 22 to the Web server 10.

Processing Details: Web Server

The conversion unit 11 of the Web server 10 performs the following process with reference to each of tables 14 and 15 of the database 50.

A Web page browsing request is transmitted from the client terminal 70 used by a user, the conversion unit 11 of the Web server 10 acquires the HTML file 22 in which the keyword has been embedded corresponding to the desired Web page is incorporated from the database 50, and performs the syntax analysis of the HTML file 22 (operation S401 and operation S402).

As a result of this syntax analysis, when the special keyword 25 in the HTML file 22 that is reserved for the conversion of the Web page component, the identification information 250 in the keyword character string in this case, is detected, a type of the keyword is identified from the information 251 indicating a type of the keyword to be converted (operation S403 and operation S404). Further, a value of the parameter (information/a variable number used for the conversion) 252 attached (added) to the information 251 indicating a type of the keyword to be converted (operation S405) is acquired (operation S405). The information of the cookie 60 is processed as a type of the parameter.

The conversion unit 11 refers to the keyword table 14 and the dynamic data table 15 according to need, then converts the keyword (keyword conversion) into a character string according to the predetermined rule, that is, logic for each type of the keyword (operation S406). In the keyword conversion, when the cookie 60 is transmitted from the client terminal 70, the conversion process can be changed according to the content thereof (according to cookie interlocking).

After generating the HTML files 12 to which the keyword conversion process is applied, the conversion unit 11 transmits (transmits back) the HTML file 12 as a desired Web page to the client terminal 70 through the communication interface (operation S407 and operation S408).

The types of the keyword to be converted by the Web server 10 are the following items:

A: Pattern that does not need the cookie interlocking; (A-1) Replace with predetermined words, e.g., a name of a site (page) and the like; (A-2) Replace with words that can be derived by specific logic, e.g., example, a present date time and the like; (A-3) Replace with session information, e.g., browser information of a user. (A-4) Derive information by referring to the database, e.g., a price of merchandise and the like;

B: Pattern that cooperates with a cookie; (B-1) Replace with data of the cookie itself, e.g., a session ID and the like; (B-2) Convert the data of the cookie by referring to a specified table, e.g., referring to a merchandise list table from the merchandise number recorded in the cookie and converting into a merchandise name; and (B-3) Convert the data of the cookie by using a key of a database reference, e.g., referring to the user information table from the user information recorded in the cookie and converting the data into a user name.

First Specific Example: A Keyword for Converting into the Present Date and Time

Next, as a first specific example, description is made of the case of processing the keyword for converting into the present date and time in the conversion unit 11 of the Web server 10.

A format of the special keyword 25 for converting into the present date and time can be specifically expressed in “<$KEY_DATE (form)>”. In this case, “(form)” is a parameter (variable number) showing a format of the date display. When the Web server 10 converts a component of a certain Web page provided to a general user, the Web designer specifies any number of the following formats through the above described editor screen in the Web designer terminal 20.

1: YYYYMMDD

2: YYYY/MM/DD

3: MM/DD/YY

Further, the format of the special keyword 25 for converting into the present time can be specifically expressed in “<$KEY_TIME (form)>”. In this case, “(form)” is a parameter indicating a format of the time display. The Web designer specifies any number of the following formats.

1: HHMM

2: HHMMSS

3: HH:MM

4: HH:MM:SS

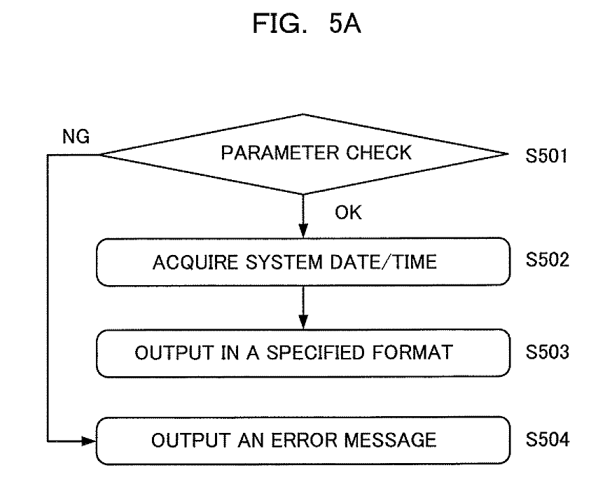

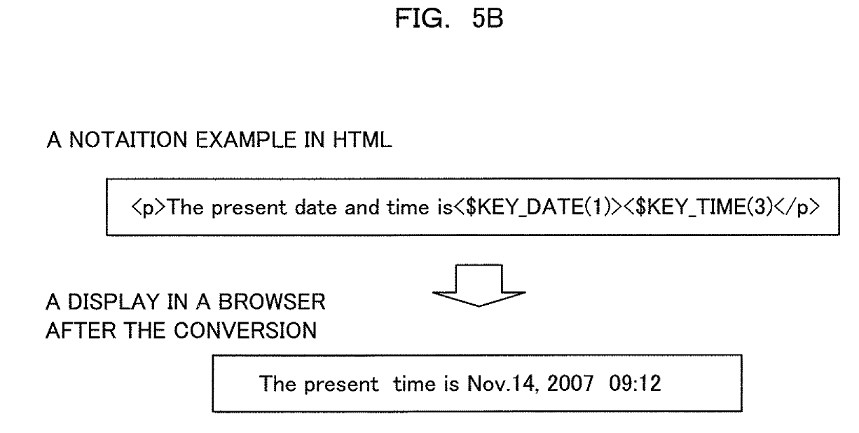

In addition to the above described series of processes in operation S401 to operation S408, more specifically, the conversion unit 11 of the Web server 10 identifies a type of the keyword when the special keyword (the character string including the parameter) 25 in the HTML file 22 that is reserved for the conversion of the Web page component is detected as a result of the syntax analysis. After that, the conversion unit 11 checks normality of the parameter 252 added to the information 251 indicating a type of the keyword to be converted (operation S501 in FIG. 5A).

For example, “DATE” is identified as a type of the keyword, the conversion unit 11 checks which the parameter (form) added to this keyword is any of the values “1” to “3”.

If the parameter is normal, the conversion unit 11 acquires a system date and time from the Web server 10 and outputs the system date and time in a specified format (operation S502 and operation S503). In this case, the conversion unit 11 adds characters and the like such as “the present date and time is” necessary for an HTML notation to the acquired data by referring to the keyword table 14, then outputs the acquired data.

The conversion unit 11 transmits the HTML file 12 as a Web page desired by a general user to the client terminal 70 after generating the HTML file 22 to which the keyword conversion process is applied, as well as in the series of processes in operation S401 to operation S408.

As shown in FIG. 5B, the notation in the HTML file 12 in this case is “<p> The present date and time is <$KEY_DATE1)><$KEY_TIME(3)></p>”. Further, the display of the browser (after the keyword conversion) in the client terminal 70 is “The present date and time is Nov. 14, 2007 09:12”.

Meanwhile, if the parameter is abnormal (operation S501), an error message is output (operation S504). This error message is transmitted to the Web designer terminal 20 and the like from the Web server 10 according to need, then displayed in the browser. Thus, the Web designer can input a correct parameter again.

Second Specific Example: Keyword for Converting into User Information

As a second specific example, description is made of the case of processing the keyword for converting into user information by a pattern of using the cookie 60.

The format of the special keyword 25 for converting into the user information can be specifically expressed in “<$KEY_USERDATA (method, ID, item)>”. In this case, “(method, ID, item)” is the parameter 252. When the Web server 10 converts the component of a certain Web page provided to a general user, the Web designer specifies any number of the following parameters through the above described editor screen in the Web designer terminal 20.

method: A method for specifying a user ID

1: Specify directly by an ID parameter

2: Refer to a cookie

ID: A parameter for specifying a user ID

When method=1: Directly note a user ID

When method=2: An item name when reading from a cookie

item: A number of an item to be acquired from a user DB

1: Name

2: Address

3: Phone number

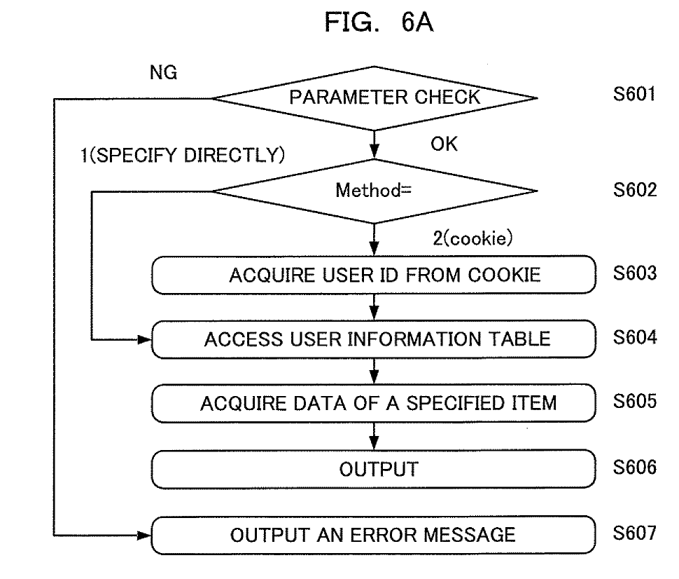

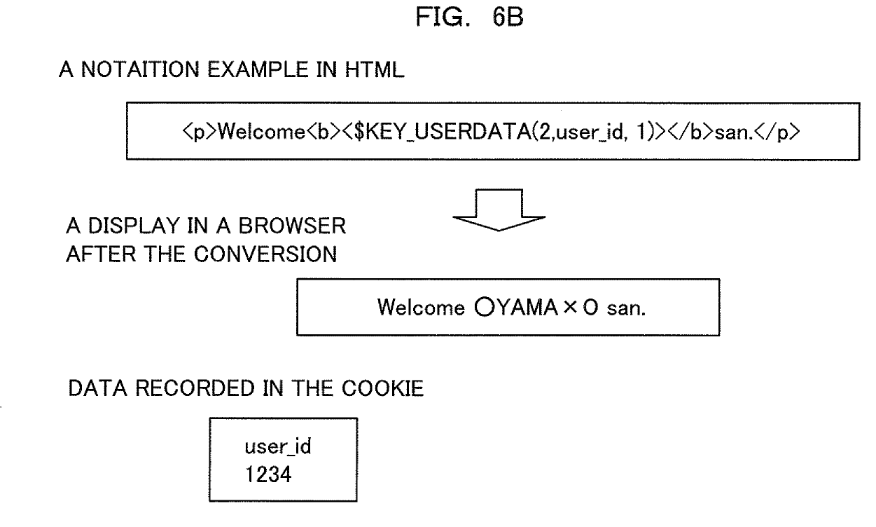

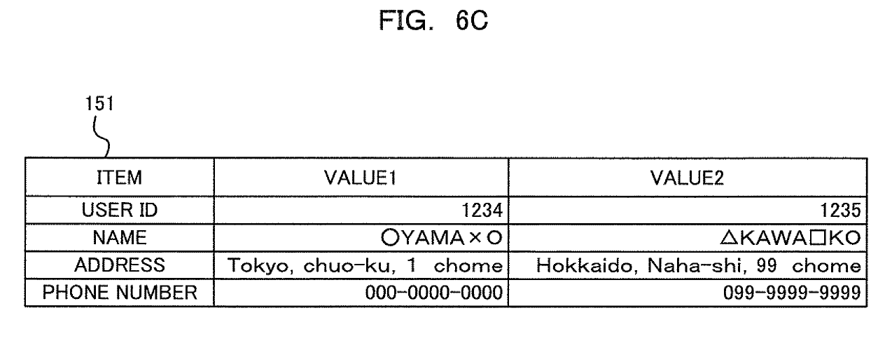

In addition to the above described series of processes in operation S401 to operation S408, more specifically, when the special keyword (the character string including a parameter) 25 is detected in the HTML file 22 reserved for conversion of the Web page component, the conversion unit 11 of the Web server 10 indicates a type of the keyword as a result of the syntax analysis. After that, the conversion unit 11 checks the normality of the parameter 252 added to the information 251 indicating a type of the keyword to be converted (operation S601 in FIG. 6A).

If the parameter 252 is normal, the conversion unit 11 determines whether a first parameter “method”, added to the keyword “USERDATA”, showing a method for specifying a user ID (operation S602), is the value “1” or the value “2”.

If the first parameter “method” is the value “2” (refer to a cookie), the conversion unit 11 acquires a recorded user ID “1234” (see FIG. 6B) from the cookie 60 (operation S603).

After accessing a user information table 151 shown in FIG. 6C based on the acquired user ID “1234”, the conversion unit 11 acquires data of an item specified by the value “1” of a third parameter “item” (operation S604 and operation S605). Further, each of the acquired items is added with characters such as “Welcome” necessary for HTML notation by referring to the keyword table 14, and then is output (operation S606). In this case, since the value “1” of the third parameter “item” is a number corresponding to a name, the name “∘YAMA×◯” is searched from the user information table 151.

Meanwhile, if the first parameter “method” is the value “1” (specify directly by an ID parameter (the second parameter)), the conversion unit 11 acquires and outputs the data of the item specified by the value “1” of the third parameter “item” after accessing the user information table 151 based on the user ID that is directly specified by the second parameter “ID” (operation S604, operation S605, and operation S606).

As well as in the above described series of processes in operation S401 to operation S408, after generating the HTML file 12 to which the keyword conversion process is applied, the conversion unit 11 transmits, to the client terminal 70, the HTML file 12 as a Web page desired by a general user.

As shown in FIG. 6B, the notation in the HTML file 12 in this case, is “<p>Welcome<b><$KEY_USERDATA (2,user_id,1)></b>san</p>”. Further, the display in the browser of the client terminal 70 is “Welcome ∘YAMA×◯ san”.

If the parameter 252 is abnormal (operation S601), an error message is output (operation S607). This error message is transmitted to the Web designer terminal 20 and the like from the Web server 10 according to need, then displayed in the browser. Thus, the Web designer can input a correct parameter again.

Third Specific Example: Keyword for Converting into Merchandise Information

Next, as the third specific example, description is made of processing of the keyword for converting into the merchandise information in the conversion unit 11 of the Web server 10.

A format of the special keyword 25 for converting into the merchandise information can be specifically expressed in “<$KEY_ITEMDATA (model, item)>”. In this case, “(model, item)” is the parameter 252. When the Web server 10 changes a component of a certain Web page that is provided to a general user, the Web designer specifies any number of the following parameters through the above described editor screen in the Web designer terminal 20.

model: Specify a merchandise number

item: A number of an item to be acquired from a merchandise DB

1: Merchandise name

2: Price

3: Stock quantity

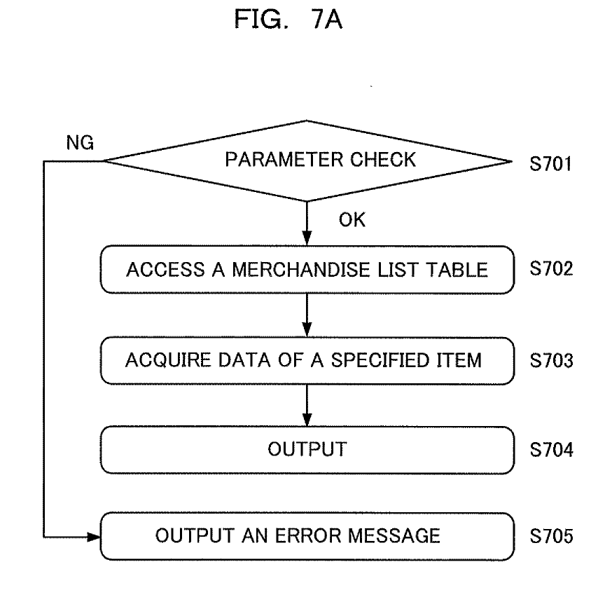

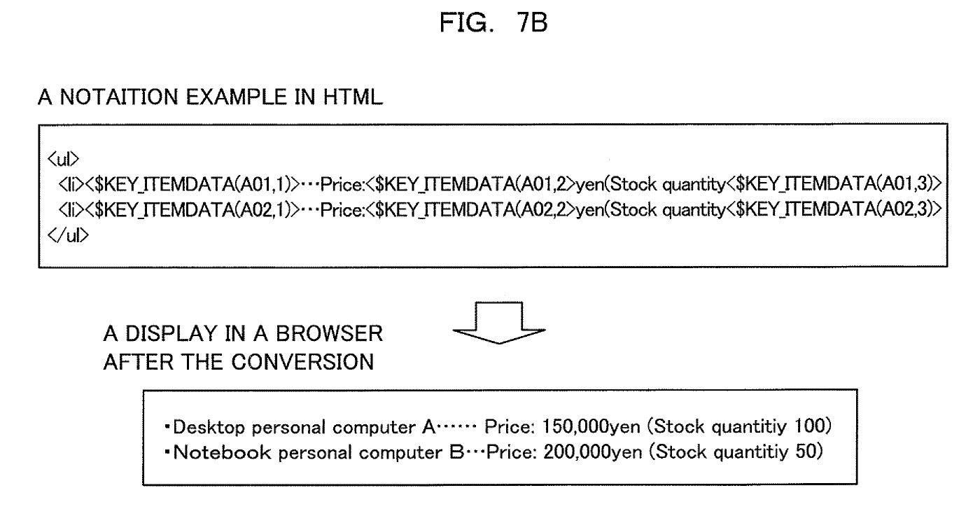

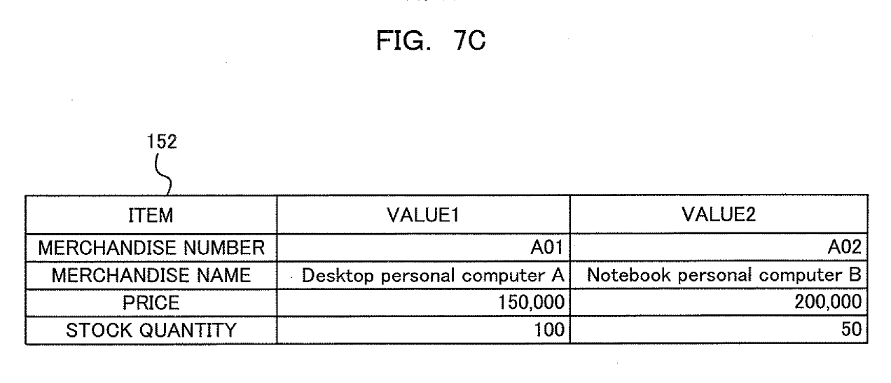

In addition to the above described series of processes in operation S401 to operation S408, more specifically, the conversion unit 11 of the Web server 10 identifies a type of the keyword when the special keyword 25 of the HTML file 22 reserved for the conversion of the Web page component is detected based on the identification information 250 in the keyword character string, as a result of the syntax analysis. After that, the conversion unit 11 checks the normality of the parameter 252 added to the information 251 indicating a type of the keyword to be converted (operation S701 in FIG. 7A).

The conversion unit 11 acquires the data of the item specified by the values “1”, “2”, and “3” of the second parameter “item” (operation S702 and operation S703) after accessing a merchandise list table 152 shown in FIG. 7C based on merchandise numbers “A01” and “A02” showed by the first parameter “model” added to a keyword “ITEMDATA”, if the parameter 252 is normal. Further, the conversion unit 11 adds characters such as “price” necessary for the HTML notation to each of the acquired item data by referring to the keyword table 14, and then outputs the data (operation S704).

In this case, since the values of the second parameter “item” are “1”, “2”, and “3”, a merchandise name, a price, and a stock quantity corresponding to the merchandise numbers “A01 ” and “A02” are searched from the merchandise list table 152.

As well as in the above described series of processes in operation S401 to operation S408, after generating the HTML file 12 to which the keyword conversion process is applied, the conversion unit 11 transmits the HTML file 12 as a Web page desired by a general user to the client terminal 70.

As shown in FIG. 7B, the notation in the HTML file 12 in this case is the following

```
  “<ul>
  <li><$KEY_ITEMDATA(A01,1)>...Price:<$KEY_ITEMDATA(A01,
2)>yen(Stock quantity<$KEY_ITEMDATA(A01,3)>
  <li><$KEY_ITEMDATA(A02,1)>...Price:<$KEY_ITEMDATA(A02,
2)>yen(Stock quantity<$KEY_ITEMDATA(A02,3)></ul>”
```

Further, as shown in FIG. 7B, the display of the browser in the client terminal 70 is shown below.

“Desktop personal computer A . . . Price: 150,000 yen (Stock quantity 100)

Notebook personal computer B . . . Price: 200,000 yen (Stock quantity 50)”

If the parameter 252 is abnormal (operation S701), an error message is output (operation S705). This error message is transmitted to the Web designer terminal 20 from the Web server 10 according to need, then displayed in the browser. Thus, the Web designer can input a correct parameter again.

Deformation Example

The process in the above described embodiment is provided as a program that can be performed by a computer, and can be provided through a record medium such as a CD-ROM and a flexible disk, and even a communication line.

Further, each process in the above described embodiment can be performed by being combined with plural processes or all of the processes.

The HTML file in the above described embodiment can be replaced with an XML (Extensible Markup Language) file or an SGML (Standard Generalized Markup Language) file that are other description language files corresponding to Web, transmitted and received according to a predetermined protocol such as an HTTP (Hyper Text Transfer Protocol).

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A server comprising:
a storing unit that receives a description language file in which a special keyword for converting a Web page component is embedded from a first device, and stores the description language file in a storage unit;
a detecting unit that detects the special keyword in the stored description language file by syntax analysis when a Web page browsing request is submitted from a second device;
a converting unit that converts the detected special keyword into a character string in accordance with a predetermined rule; and
a generating unit that generates a description language file including the converted character string to be transmitted back to the second device.

2. The server according to claim 1, wherein the special keyword includes identification information of a keyword character string, information indicating a type to be converted, and information used for conversion.

3. The server according to claim 2, wherein the information used for the conversion is added as a variable number to the information indicating a type to be converted.

4. The server according to claim 2, wherein the detecting unit detects the special keyword in the description language file based on the identification information.

5. The server according to claim 1, wherein the converting unit that converts into a character string converts a content thereof into a variable number when a cookie is transmitted from the second device.

6. The server according to claim 1, wherein the special keyword is specified by using a Web authoring tool.

7. A dynamic Web page creating method, wherein a server comprises:
receiving a description language file in which a special keyword for converting a Web page component is embedded from a first device in order to store the description language file in a storage unit;
detecting the special keyword in the stored description language file by syntax analysis of the special keyword when a Web page browsing request is submitted from a second device;
converting the detected special keyword into a character string according to a predetermined rule; and
generating a description language file including the converted character string to be transmitted back to the second device.

8. The dynamic Web page creating method according to claim 7, wherein the special keyword includes identification information of a keyword character string, information showing a type to be converted, and information used for conversion.

9. The dynamic Web page creating method according to claim 8, wherein the information used for conversion is added as a variable number to the information indicating a type to be converted.

10. The dynamic Web page creating method according to claim 8, wherein the detecting unit detects the special keyword in the description language file based on the identification information.

11. The dynamic Web page creating method according to claim 7, wherein the converting unit that converts a content thereof into a variable number when the cookie is transmitted from the second device.

12. The dynamic Web page creating method according to claim 7, wherein the special keyword is specified by using a Web authoring tool.

13. A readable medium that records a program makes a server perform:
receiving a description language file in which a special keyword for converting a Web page component is embedded from a first device;
detecting the special keyword in the stored description language file when a Web page browsing request is submitted from a second device;
converting the detected special keyword in accordance with a predetermined rule; and
generating the description language file including the converted character string to be transmitted back to the second device.
